(19) United States
(12) Patent Application Publication
(10) Pub. No.: US 2025/0020970 A1
(43) Pub. Date: Jan. 16, 2025

(54) EFFICIENT FREQUENCY CONVERSION VIA PHOTONIC RESONANCES NEAR BOUND STATES IN THE CONTINUUM

(71) Applicants: THE TRUSTEES OF THE UNIVERSITY OF PENNSYLVANIA, Philadelphia, PA (US); UNIVERSITY OF ROCHESTER, Rochester, NY (US)

(72) Inventors: Jicheng JIN, Philadelphia, PA (US); Bo ZHEN, Merion Station, PA (US); Qiang LIN, Rochester, NY (US)

(21) Appl. No.: 18/708,425

(22) PCT Filed: Nov. 8, 2022
(86) PCT No.: PCT/US2022/079496

§ 371 Date: May 8, 2024

Related U.S. Application Data
(60) Provisional application No. 63/276,992, filed on Nov. 8, 2021.

(51) Int. Cl. G02F 1/35; G02F 1/355

(52) U.S. Cl. CPC G02F 1/3534; G02F 1/3507; G02F 1/3556

(57) ABSTRACT

Methods and systems are described for conversion of an optical signal. The device may comprise a conversion layer comprising a nonlinear optical material with a surface structure disposed to receive a pump signal and cause a bound states in the continuum (BIC) optical mode. The conversion layer may be configured to convert, based on nonlinear interaction with the BIC optical mode, an incoming signal incident on the conversion layer from an incoming wavelength to a target wavelength.

### CROSS-REFERENCE TO RELATED APPLICATIONS

This application is related to U.S. Patent Application No. 63/276,992 filed Nov. 8, 2021, which is hereby incorporated by reference for any and all purposes.

### GOVERNMENT SUPPORT

This invention was made with government support under HR0011-220013 awarded by the Defense Advanced Research Projects Agency. The government has certain rights in the invention.

### BACKGROUND

A broad spectral range of electromagnetic waves is involved in human activities. The most common parts are visible light (380 nm˜750 nm), which gets its name since it can be directly seen by the eyes, and near-infrared radiation (NIR) (700 nm˜1600 nm) used by modern fiber optical communication. Generation and detection of photons in these spectral ranges have been well studied and high-performance devices are commercially available. Besides, another spectral region covering longer wavelengths from 3 um˜12 um (mid-infrared radiation, MIR) is also of interest since most thermal imaging devices work in this region. However, high-performance cameras for this spectral region are hard to make and the imaging resolution is limited by the wavelength. One potential solution is to upconvert the MIR photon into a visible or telecom one by using some nonlinear process such as sum-frequency generation (SFG). However, currently proposed state-of-the-art frequency upconversion systems are limited in both conversion efficiency and spectrum bandwidth. Thus, there is a need for a novel conversion system that is efficient and broadband.

### SUMMARY

Methods and systems are described for conversion of an optical signal. The device may comprise a conversion layer comprising a nonlinear optical material with a surface structure disposed to receive a pump signal and cause a bound states in the continuum (BIC) optical mode. The conversion layer may be configured to convert, based on nonlinear interaction with the BIC optical mode, an incoming signal incident on the conversion layer from an incoming wavelength to a target wavelength.

An example method may comprise receiving, by a conversion layer comprising a nonlinear optical material with a surface structure, a pump signal. The method may comprise causing, by the conversion layer and based on the pump layer, a bound states in the continuum (BIC) optical mode. An example layer may comprise converting, based on nonlinear interaction with the BIC optical mode, an incoming signal incident on the conversion layer from an incoming wavelength to a target wavelength.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows conversion of an optical signal using an example conversion layer according to the techniques of the present disclosure.

FIG. 2A shows simulation results for single layer conversion efficiency.

FIG. 2B shows BIC designs are flexible and can be found in LiNbO₃ devices of other thicknesses, ranging from below 1 um to over 5 um.

FIG. 3A shows simulation results of a BIC mode that illustrate the delocalized nature of the mode.

FIG. 3B shows results demonstrating a BIC with Q over 1,000,000.

FIG. 3C shows a track record in improving and demonstrating ultra-high-Q BICs over the past decade.

FIG. 4A shows a brief survey of some examples of the LiNbO₃ nanophotonic devices fabricated according to the present techniques.

FIG. 4B shows transmission traces of a high-Q micro-ring resonator.

FIG. 5A shows an example periodic structure.

FIG. 5B shows another example periodic structure.

FIG. 6A shows an example cross-section of an example device. The device may comprise a conversion layer.

FIG. 6B shows graphs illustrating that BIC wavelength can be modified according to different design specifications.

FIG. 7A shows a cross-section of an example device.

FIG. 7B shows reflection and transmission of light through an example device.

FIG. 7C shows a graph illustrating Q for different dimensions.

FIG. 7D shows a graph illustrating Q according to dimension and angle.

FIG. 8A shows a cross-section of an example device.

FIG. 8B shows conversion efficiency of an example device.

FIG. 9A shows wavelength and angle for example devices.

FIG. 9B shows conversion efficiency and angle for example devices.

FIG. 10A shows visible output flux and MIR output flux for example devices.

FIG. 10B shows up conversion efficiency and MIR output flux for example devices.

FIG. 11 shows conversion efficiency and MIR power for example devices.

FIG. 12 shows a fabrication process for making an example device.

FIG. 13A shows a cross section of an example conversion layer.

FIG. 13B shows another view of an example conversion layer.

FIG. 14A shows a view of an example conversion layer.

FIG. 14B shows another view of an example conversion layer.

FIG. 15A shows a view of a device in a fabrication step. A dicing saw may be applied.

FIG. 15B shows a view of a device in another fabrication step.

FIG. 15C shows a view of a device in another fabrication step.

FIG. 16A shows a conversion layer before wet etching.

FIG. 16B shows a conversion layer after wet etching for the first time.

FIG. 16C shows a conversion layer in water after wet etching for the second time.

FIG. 16D shows a conversion layer after drying after wet etching for the second time.

FIG. 17 shows progression of fabrication tests from 60 μm to 300 μm.

FIG. 18A shows a horizontal view of a conversion layer for design parameter confirmation.

FIG. 18B shows a 45 degree tilt view of a conversion layer for design parameter confirmation.

FIG. 19 shows a testing schematic.

FIG. 20 shows another testing schematic.

FIG. 21A shows wavelength shift due to wet etching.

FIG. 21B shows a conversion layer thinned by wet etching.

FIG. 22 shows BIC characteristics including wavelength and angle as well as intensity and wavelength.

FIG. 23A shows an example conversion layer.

FIG. 23B shows a cross-section of an example conversion layer.

FIG. 23C show measurements of a conversion layer.

FIG. 23D shows a view of an example conversion layer.

FIG. 23E shows a view of an example conversion layer.

FIG. 24 shows a progression of a conversion layer.

FIG. 25A shows a setup for a conversion layer.

FIG. 25B shows a graph illustrating SFG intensity and wavelength for the example conversion layer.

FIG. 26 shows an updated pulsed layer setup.

FIG. 27 shows observation of upconversion of an example device.

### DETAILED DESCRIPTION OF ILLUSTRATIVE EMBODIMENTS

The disclosed devices provide a highly efficient and broadband method for conversion (e.g., up-conversion, down-conversion) which is needed in many optical processing applications including imaging and optical communications. Compared with the previously proposed state-of-the-art frequency conversion systems, our system is superior in both efficiency and bandwidth, based on the advantages in four main ways. Though the disclosure primarily refers to up-conversion, it should be understood that the same techniques can be used to achieve down-conversion.

The disclosed devices may include any combination of the following features. 1. An ultra-high pump enhancement: we use ultra-high-Q bound states in the continuum (BICs), where we have demonstrated record-high Q>1,000,000. This enhancement reduces the required pump fluence in free space at the meanwhile. In addition, for imaging applications, infinite spatial resolution is enabled by the delocalized nature of BIC. Thanks to the translational invariant nature of the BIC photonic crystal in the device plane, the BIC mode of the pump wave exhibits an optical mode field uniformly distributed across the entire device structure without any “hot spots.”

2. A highly nonlinear material with high power handling capability: the disclosed device is demonstrated with LiNbO3 since the combination of high nonlinear coefficient and wide bandgap enables high power handling capability and high conversion efficiencies. Our team has developed world-leading expertise in the design/fabrication of high-quality on-chip LiNbO3 nanophotonic devices, which builds a solid foundation to deliver this up-conversion system.

3. A long interaction length: A novel BIC structure as disclosed not only allows significant interaction length in a single device layer with conversion efficiency but also enables cascading multiple (up to 10) device layers in a coherent manner to further enhance η. In contrast, current nanoplasmonic and metasurface approaches for enhancing nonlinearity rely essentially on squeezing the optical field into a small volume, which severely limits the nonlinear interaction length and thus conversion efficiency.

4. Automatic phase matching: the phase-matching condition is automatically satisfied in our proposed system due to the two-dimensional nature of BICs. Besides, by alternating the z-axis of LiNbO3 (poling), we can easily quasi-phase-match in the out-of-plane direction over the entire MIR band. In comparison, bulk nonlinear medium/waveguide exhibits narrow phase-matching bandwidth. Besides, the bandwidth also benefits from that we only resonantly enhance the pump laser but not the MIR signal.

For the application part, one concrete application is to make a night vision eyeglass, which is urgently needed for some defense purposes. The disclosed method can upconvert ambient IR light (about 1 μW/cm2) into visible light at the fluence level of 1˜10 nW/cm2 that is bright enough to be seen directly by human eyes.

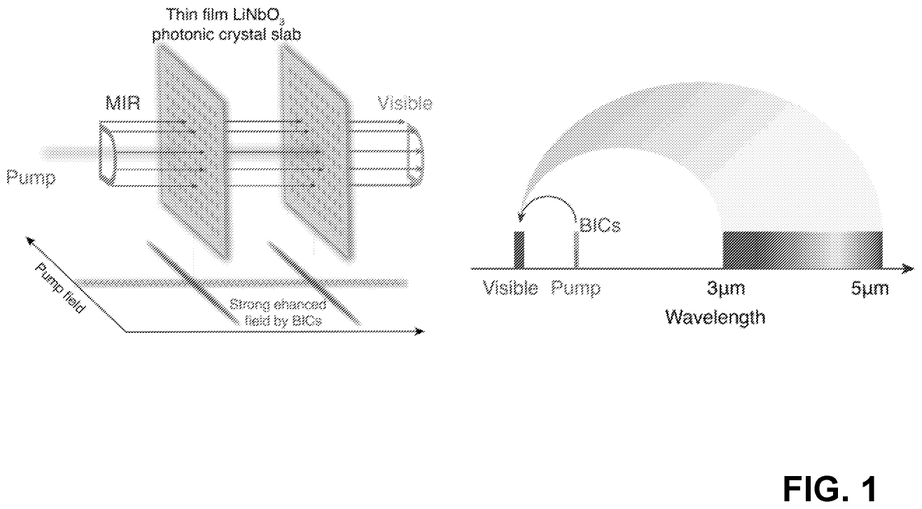

Disclosed herein is a way to achieve efficient and broadband parametric upconversions using high-Q resonance-enhanced SFG supported by nonlinear materials. Disclosed herein is presented achievement of this upconversion method with a concrete example that converts the 3 um-5 um MIR photons into visible photons. By detailing this example, key points of the disclosed techniques are provided that make the disclosed techniques superior to the previous state-of-the-art in both efficiency and bandwidth. The parameters and materials are designed and optimized for specific wavelength ranges, aiming at achieving thermal imaging. However, our disclosure isn't limited to this specific design. A schematic of an example disclosed device is presented in FIG. 1.

FIG. 1 shows conversion of an optical signal using an example conversion layer according to the techniques of the present disclosure. The conversion may comprise parametric upconversion. The conversion may be based on high Q resonances in an example thin-film LiNbO₃ photonic crystal slab. MIR (3-5 um) photons are upconverted into visible (580-700 nm) by a 780 nm pump via the nonlinear sum-frequency generation process.

The nonlinear photonic crystal supports a high-Q resonance which origins from optical bound states in the continuum (BICs). The pump frequency matches the resonance frequency and the field is strongly enhanced as a result. MIR photons are then upconverted into visible ones via the SFG process due to the presence of the second-order nonlinear susceptibilities d₃₃ of LiNbO₃. Based on the configuration of our setup, the efficiency of parametric upconversion, η, for a broadband signal is given by the following expression:

$$η = 2 {π}^{2} {Z}_{0} {\underbrace{( Q \cdot {I}_{\text{?}} )}}_{Sec 4.2} \times {\underbrace{{( {𝒳}^{( 2 )} )}^{2}}}_{4.6} \times {\underbrace{( \frac{{L}^{2}}{{λ}_{\text{?}}^{2}} )}}_{4.4 \& 4.5} \times {\underbrace{sin {c}^{2} ( Δ {k}_{\text{?}} \times L )}}_{4.3} \qquad ( Eq . 1 )$$

$$\text{?} \text{indicates text missing or illegible when filed}$$

where Z₀ is the free-space impedance (377Ω). Iₚᵤₘₚ is the pump fluence in free space. Q is the quality factor of the pump resonance. χ⁽²⁾ is the second-order nonlinear coefficient of the upconversion material. λᵤₚ is the upconverted wavelength. L is the interaction length between the pump and the broadband signal. Δk is the momentum mismatch in the SFG process, which governs the bandwidth of frequency up-conversion. As shown in Eq. (1), four key factors are underlying the performance of parametric upconversion:
(1) A high-Q pump resonance. The resonance effect will drastically enhance the pump field inside the structure, which increases the upconversion efficiency η by a factor of about Q.
(2) A highly nonlinear material free from linear absorption and nonlinear saturation. A strong quadratic nonlinearity is important for parametric up-conversion but the overall efficiency is ultimately limited by absorption and saturation.
(3) A long interaction length. Parametric upconversion requires an adequate interaction length to accumulate enough strength of SFG.
(4) Phase matching over a broad bandwidth.

Our major innovation is in the unique combination between ultra-high-Q nanophotonic resonances and nonlinear materials, which is superior to the state of the art in all these 4 key factors:

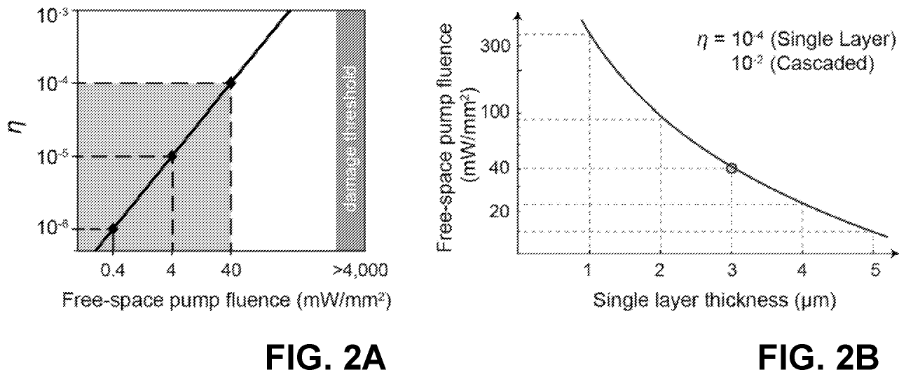

1. An ultra-high pump enhancement: we use ultra-high-Q bound states in the continuum (BICs), where we have demonstrated record-high Q>1,000,000 [1-3]. Using a BIC mode, we will increase the effective χ⁽²⁾ of LiNbO₃ by over 2,000 times to about χ⁽²⁾^{_{eff}}=10⁵ pm/V, entering the non-perturbative regime of nonlinear optics. FIG. 2A shows simulation results for single layer conversion efficiency. The results show that upconversion efficiency for the disclosed results reaches 10⁻⁴ in a single layer of LiNbO₃ BIC device, under a modest pump fluence of 40 mW/mm². The intra-cavity fluence is 100 times lower than the damage threshold of LiNbO₃ (gray area). As shown in FIG. 2A, this enhancement reduces the required pump fluence in free space at the meanwhile. The Qs can be tuned in a large range by tuning the structural parameters. In some scenarios, structures with Q below 100 may not be used for the present techniques.

2. A highly nonlinear material with high power handling capability: the disclosed device is demonstrated with LiNbO₃ since the combination of high nonlinear coefficient and wide bandgap enables high power handling capability and high conversion efficiencies. [7-14] Our design is not limited to LiNbO₃ but can be extended to a large number of nonlinear materials with second-order susceptibilities, such as GaAs, AlN, etc, according to different applications.

3. A long interaction length: An elegant feature of the proposed BIC structure is that our design is very flexible and can be easily adapted to different layer thicknesses. FIG. 2B shows BIC designs are flexible and can be found in LiNbO₃ devices of other thicknesses, ranging from below 1 um to over 5 um. Keeping the conversion efficiency fixed at 10^{A} in a single layer, the required free-space pump fluence can further be reduced with BICs thicker than 3 um. Again, the results are confirmed by the full Maxwell simulation in COMSOL. As shown in FIG. 2B, for each thickness of the LiNbO3 layer, BICs can be designed accordingly. This helps increase the nonlinear interaction length and thus up-conversion efficiency with a thicker LiNbO₃BIC layer. In addition, the disclosed novel BIC structure not only allows significant interaction length in a single device layer with conversion efficiency but also enables cascading multiple (up to 10) device layers in a coherent manner to further enhance r. In contrast, current nanoplasmonic and metasurface approaches [15,16] for enhancing nonlinearity rely essentially on squeezing the optical field into a small volume, which severely limits the nonlinear interaction length and thus conversion efficiency.

Automatic phase matching: the phase-matching condition is automatically satisfied in our proposed system due to the two-dimensional nature of BICs. Besides, by alternating the z-axis of LiNbO₃ (poling), we can easily quasi-phase-match in the out-of-plane direction over the entire MIR band. In comparison, bulk nonlinear medium/waveguide exhibits narrow phase-matching bandwidth. [17,18].

Besides the above 4 key factors, the disclosed approach is generically broadband, as we may only resonantly enhance the pump laser but not the MIR signal. We note that there can accidentally be some low Q resonances at the visible wavelength that enhance the efficiency at some wavelengths.

In addition, for this specific imaging application, infinite spatial resolution is enabled by the delocalized nature of BIC. Thanks to the translational invariant nature of the BIC photonic crystal in the device plane, the BIC mode of the pump wave exhibits an optical mode field uniformly distributed across the entire device structure. As a result, the upconversion process will be uniform across the entire image plane without any “hot spots”. This unique property translates into advantages in this application, as our BIC modes can provide an extremely high (virtually infinite) spatial resolution that is limited only by the lattice size of the underlying photonic crystal, which is more than an order of magnitude smaller than the MIR wavelength.

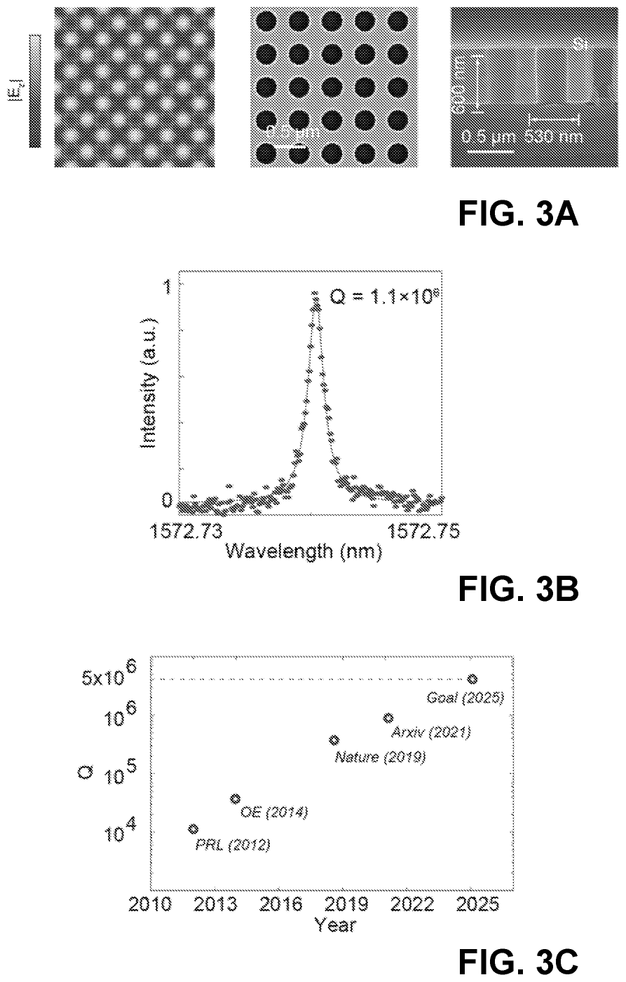

The BIC approach is leveraged on our pioneering expertise in developing BICs in nanophotonic structures. Over the past decade, we have made a series of important discoveries in BICs, including (1) the first experimental demonstrations of BICs in photonic crystal slabs [1, 5]; (2) the first realization of the topological nature of BICs [6]; (3) the discovery of single-sided BICs [3]; (4) demonstration of ultra-high-Q BICs with Q robustly over 400,000 [2]; (5) demonstration of a miniaturized BIC with Q over 1,000,000 (arXiv 2021). FIG. 3A shows simulation results of a BIC mode that illustrate the delocalized nature of the mode. SEM images of an example BIC fabricated in the silicon-on-insulator platform. FIG. 3B shows results demonstrating a BIC with Q over 1,000,000. FIG. 3C shows a track record in improving and demonstrating ultra-high-Q BICs over the past decade, proving that the proposed scheme and goals in this program are practical and achievable. FIG. 3A and FIG. 3 show an example where the BIC developed in silicon photonic crystals exhibits a high optical Q of 1,100,000 in the telecom band (FIG. 3B). Because of our contributions, we were invited to write the first major review paper on this topic [4]. The advance of our developed BIC technology is summarized in FIG. 3C.

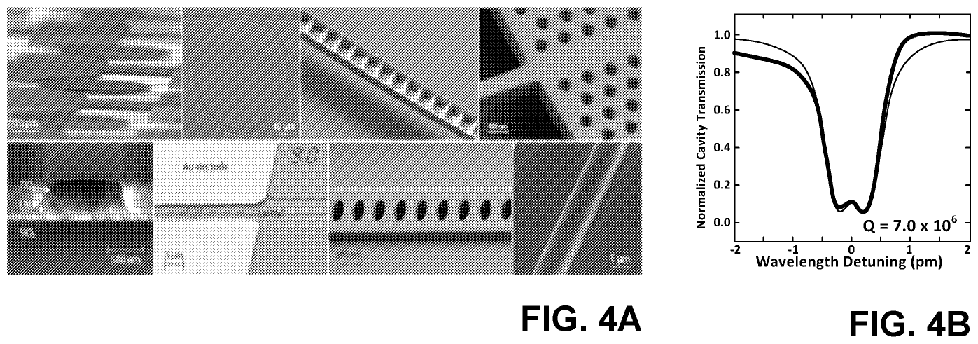

We have also developed world-leading expertise in the design/fabrication of high-quality on-chip LiNbO₃ nanophotonic devices [7-14]. Some examples are shown in FIGS. 4A-B. FIG. 4A shows a brief survey of some examples of the LiNbO₃ nanophotonic devices fabricated according to the present techniques. FIG. 4B shows transmission traces of a high-Q micro-ring resonator. The LiNbO₃ micro-ring resonators feature an optical Q up to 7 million that corresponds to an extremely low propagation loss of only ˜6 dB/m. In particular, the photonic crystal nanobeam resonator features an optical Q of 1.4 million that is the highest ever reported on LiNbO3. We will leverage this strong expertise in the proposed research program for BIC-based parametric up-conversion.

The disclosed techniques can be directly applied in practical applications. Based on BIC-enhanced sum-frequency generation (SFG), the case we present above will convert ambient IR light (about 1 μW/cm2) into visible light at the fluence level of 1˜10 nW/cm² that is bright enough to be seen directly by human eyes. This will be of great use in some defense applications such as compact night vision eyeglasses.

Given the novelty of the proposed approach, it is anticipated that significant intellectual property (IP) will be generated. With the appropriate IP in place, technology transition can occur with little or no advance planning other than the natural drive to see exciting technology commercialized. The formation of startup companies or the recruitment of key individuals by companies interested in acquiring technology is then the normal pathway for what might be called a “passive” process of technology transfer.

### Additional Information

The disclosed device can convert light with low frequency ω₁ into high frequency ω₂ with the presence of a pump light at ω₃=ω₂−ω₁. The fundamental scientific mechanism is called the sum-frequency generation (SFG).

A typical situation is to upconvert a MIR light (3 um˜5 um) into a visible one (380 nm˜750 nm). In this situation, the pump light can be chosen for example between 750 nm˜900 nm. Once chosen, the pump wavelength can be fixed and doesn't have to be tuned. The above wavelength ranges are not accurately defined and can be extended in real products according to the application requirement.

The disclosed device may be made from nonlinear optical materials. Currently, we use LiNbO3, but the design also applies to other materials such as MgO:LiNbO3, GaAs, InP, AlGaAs, AlN, AlScN, etc.

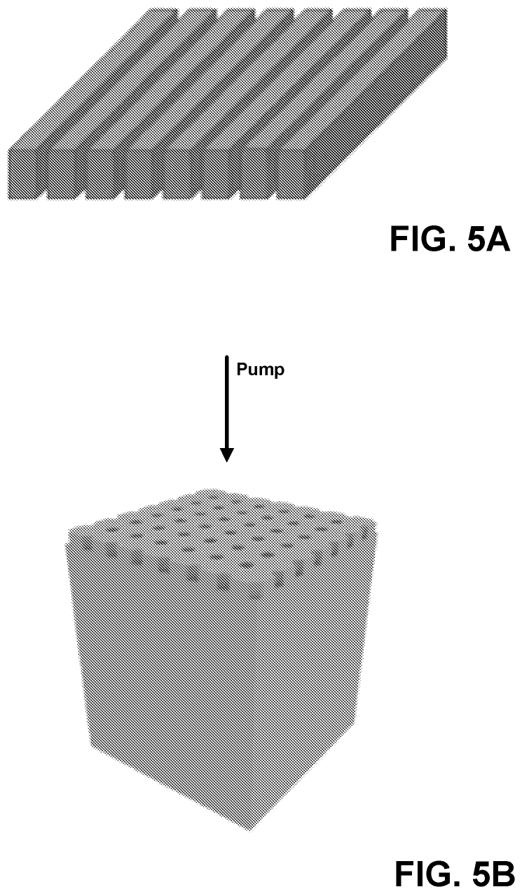

The disclosed device may comprise a periodic/semi-periodic structure. FIG. 5A-B show example periodic structures. As shown in FIG. 5B a pump laser may be directed at the surface of the periodic structure. FIG. 5A shows an example one dimensional structure. The structure may comprise slots etched into a thin film with periodicity a. In this example, a film may be etched through with a straight side wall. The film may be partially etched and the etching depth and width are tuned. The example structure may have any shape sidewall. The structure may be chirped into a semi-periodic structure. The structure may comprise many slots in one period, making it a super-cell structure.

FIG. 5B shows an example two dimensional structure. Holes may be etched into a thin film with a periodicity a. A film may be partially etched through with a straight side wall. The structure may be full-etched. The structure may have any shape sidewall. The hole shapes may be changed to any appropriate shape to meet design specifications. The structure may be chirped into a semi-periodic one. The periodicity may be different in different directions (e.g., x and y directions). The structure may comprise many holes in one period, making it a super-cell structure.

The periodicity may be picked between the pump wavelength and the output wavelength to have the best performance. However, one can go beyond this range with the price of losing some bandwidth and efficiency.

The thickness of the film can be chosen in a large range, usually with 0.2˜10 times the pump wavelength, but can go beyond this range.

The structure can be either suspended in the air or have some substrate. The substrate can be engineered, for example into a distributed Bragg reflector (DBR) mirror.

The structure supports high-Q resonances. The high-Q resonances usually origin from a bound state in the continuums (BICs) or quasi-BICs. The Qs can be tuned in a large range up to infinity.

The pump beam is set to match the frequency of one high-Q resonance.

In different situations, different Qs can be chosen. In some scenarios, Qs below 500 may not be applicable to the disclosed techniques.

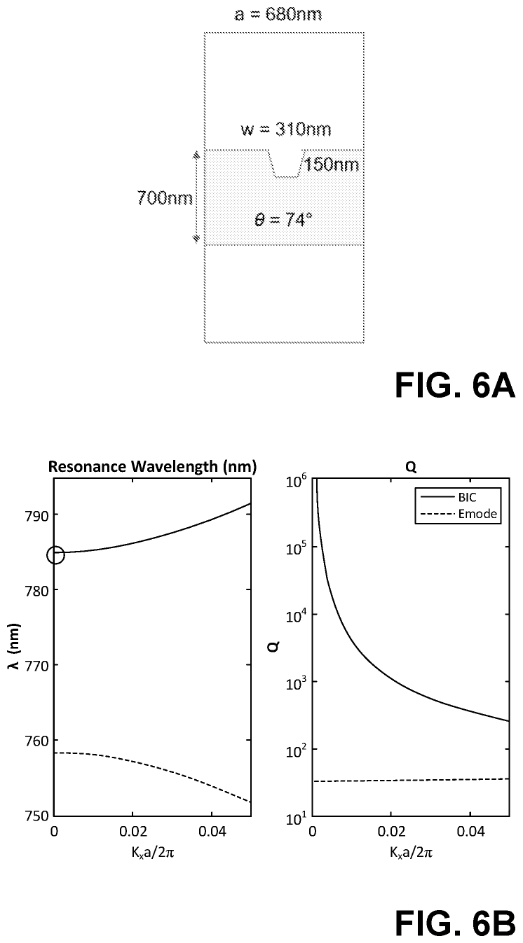

FIG. 6A shows an example cross-section of an example device. The device may comprise a conversion layer. Example dimensions are provided, but any appropriate dimensions may be used.

FIG. 6B shows graphs illustrating that BIC wavelength can be modified according to different design specifications (e.g., pitch, etching width, angle, and depth)

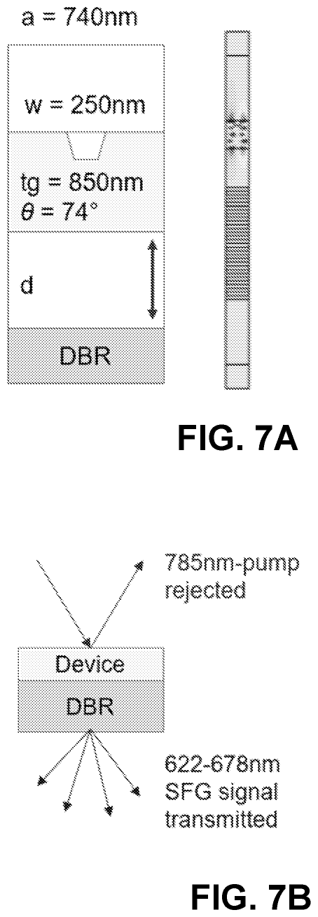

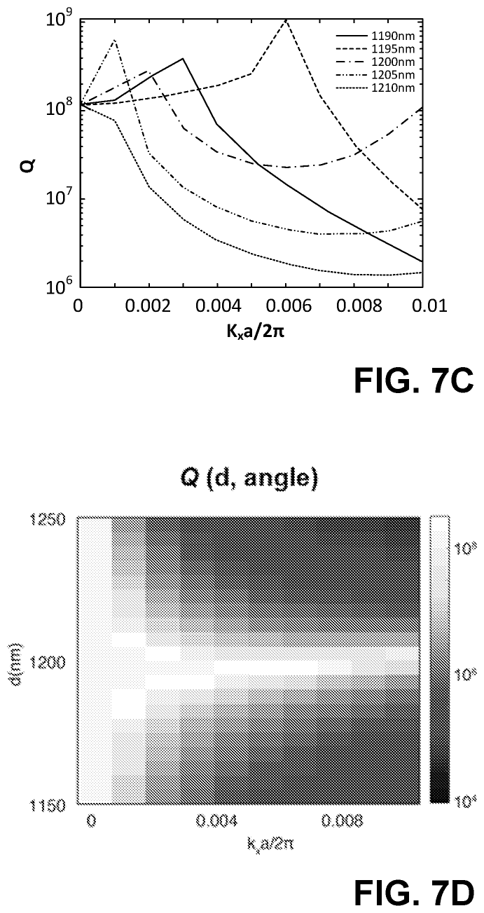

FIG. 7A shows a cross-section of an example device. The device may comprise a conversion layer separated from a distributed Bragg reflector (DBR). Example dimensions are provided, but any appropriate dimensions may be used.

FIG. 7B shows reflection and transmission of light through an example device.

FIG. 7C shows a graph illustrating Q for different dimensions.

FIG. 7D shows a graph illustrating Q according to dimension and angle.

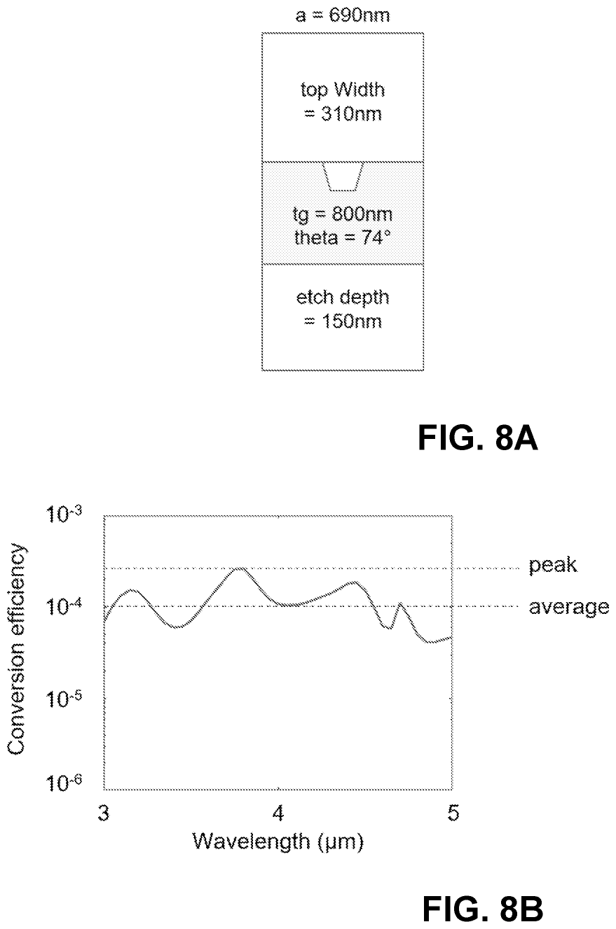

FIG. 8A shows a cross-section of an example device.

FIG. 8B shows conversion efficiency of an example device.

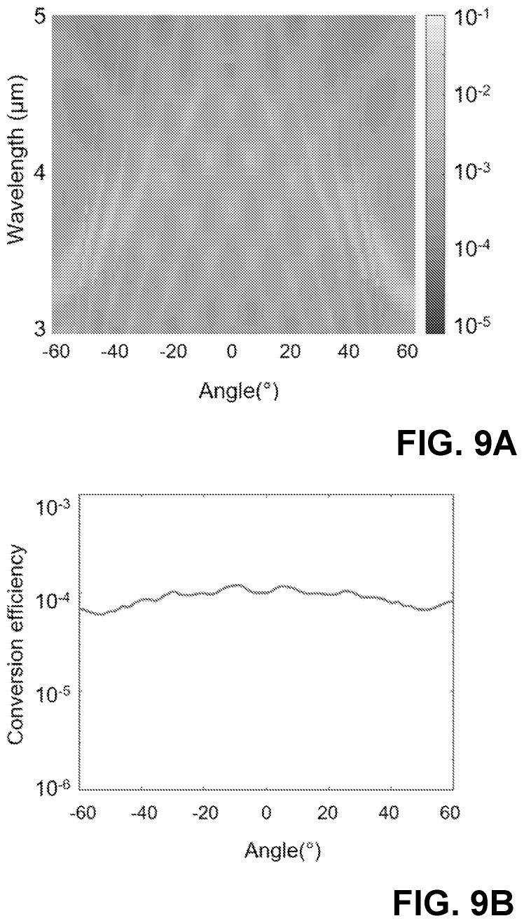

FIG. 9A shows wavelength and angle for example devices.

FIG. 9B shows conversion efficiency and angle for example devices.

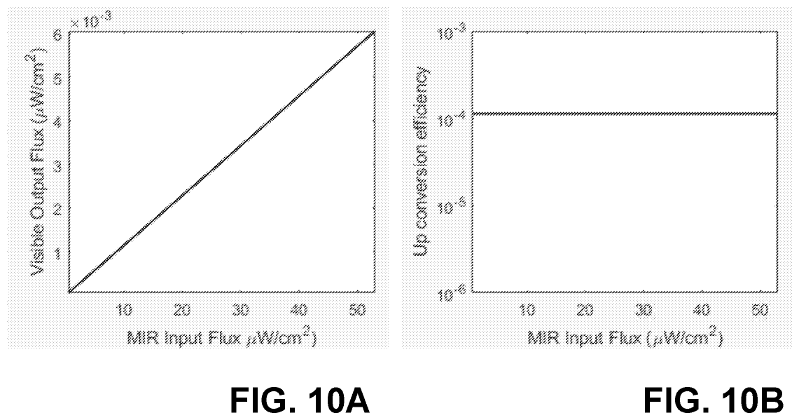

FIG. 10A shows visible output flux and MIR output flux for example devices.

FIG. 10B shows up conversion efficiency and MIR output flux for example devices.

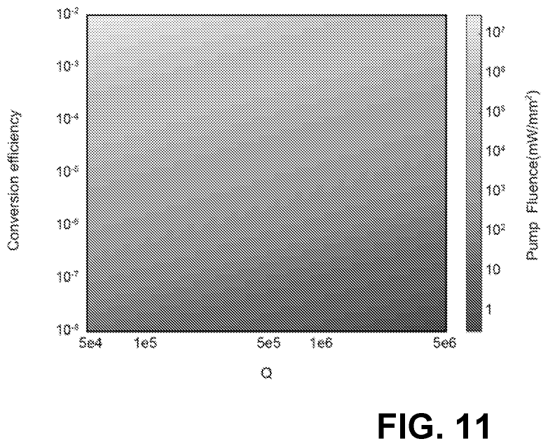

FIG. 11 shows conversion efficiency and MIR power for example devices. The device may comprise 10 um thick PhC.

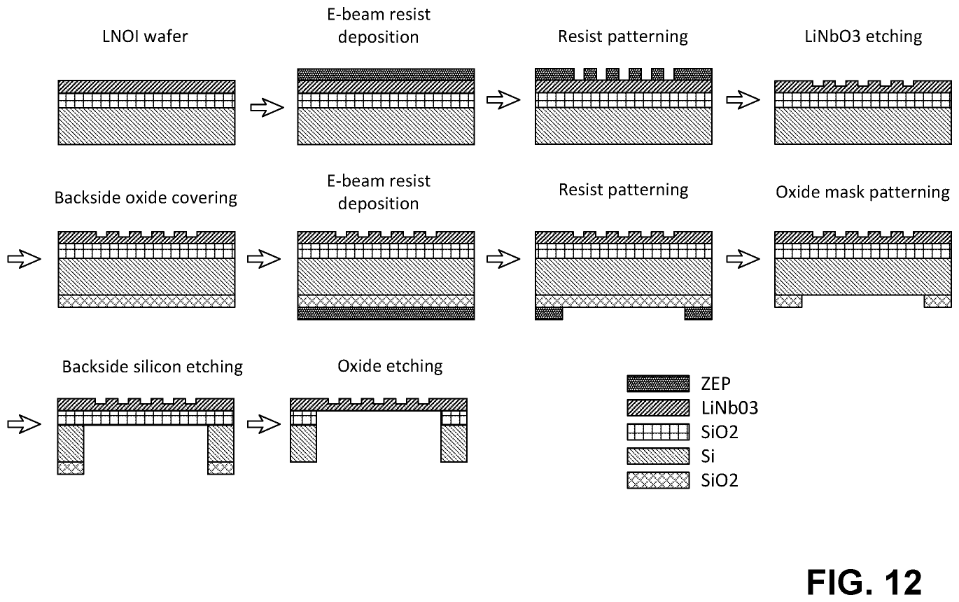

FIG. 12 shows a fabrication process for making an example device.

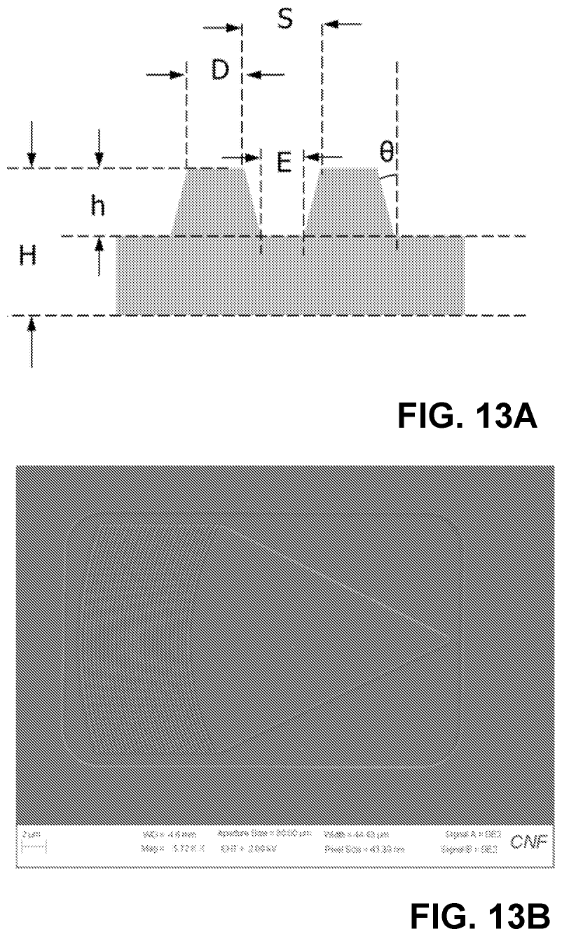

FIG. 13A shows a cross section of an example conversion layer. The etched depth may be within 6 nm of a specified value. An example etch depth may comprise 150 nm. The minimum top width (D) may be greater than 96 nm. One example minimum top width is 370 nm. The minimum top spacing (S) may be 180 nm or greater. An example minimum top spacing may be 310 nm. The minimum trench width (E) may be 80 nm or greater. An example minimum trench width may be 270 nm. The sidewall angle (θ) may be 74±1 degree.

FIG. 13B shows another view of an example conversion layer.

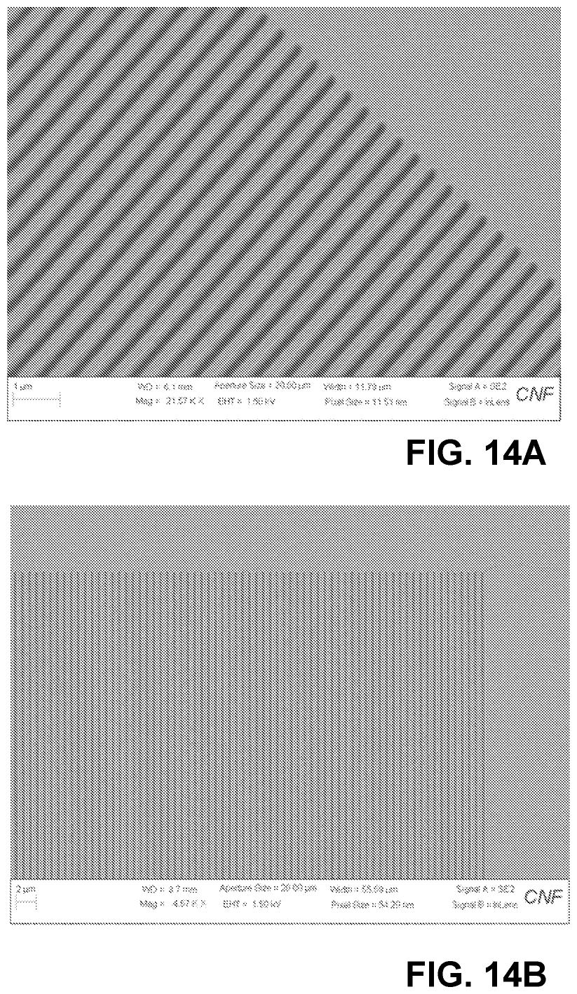

FIG. 14A shows a view of an example conversion layer.

FIG. 14B shows another view of an example conversion layer. The conversion layer and/or device comprising the conversion layer may comprise an area greater than (300 um)².

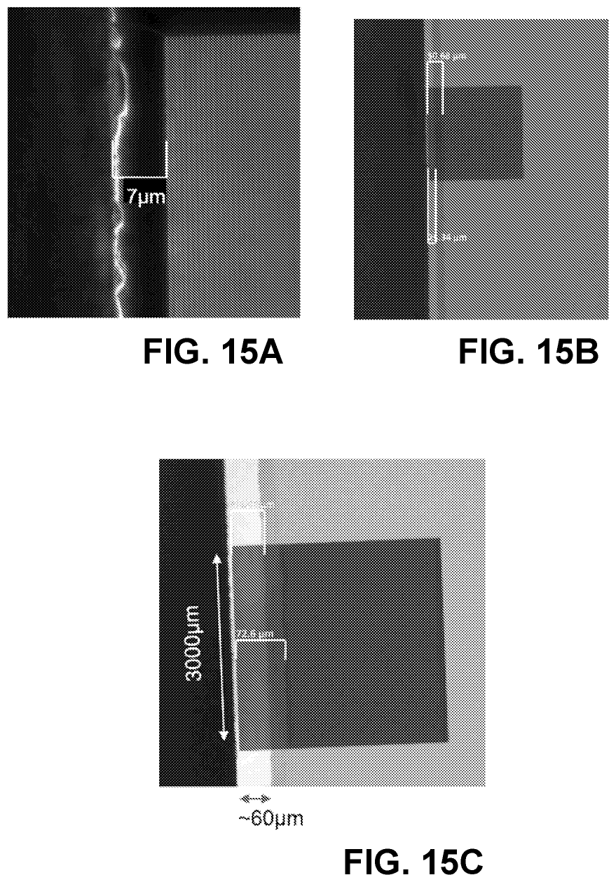

FIG. 15A shows a view of a device in a fabrication step. A dicing saw may be applied.

FIG. 15B shows a view of a device in another fabrication step. A sample is shown in a 25 percent HF solution. The sample may remain in the solution for 20 minutes.

FIG. 15C shows a view of a device in another fabrication step. A sample is shown in air. The sample may be put in 25 percent HF solution for 40 minutes.

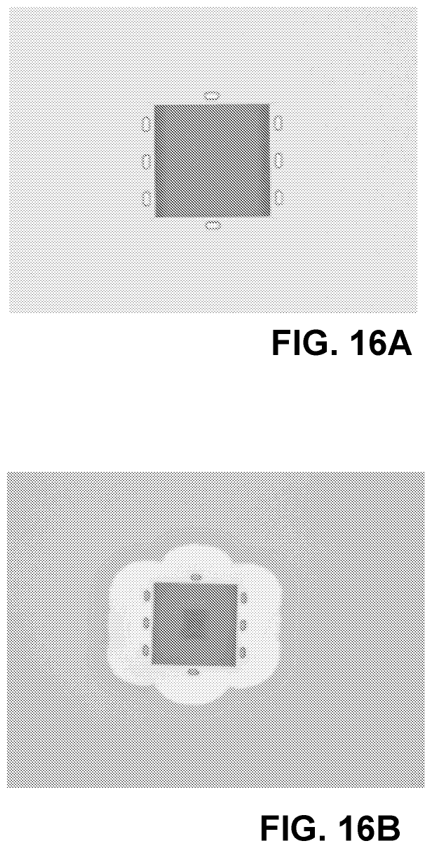

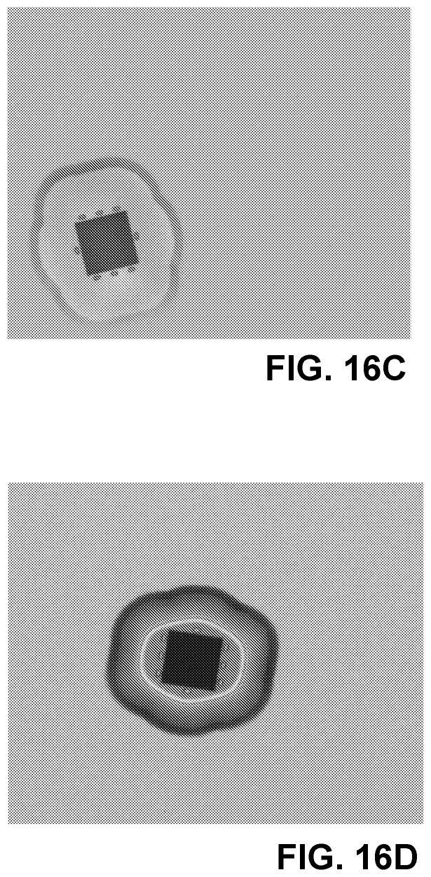

FIGS. 16A-D shows fabrication progress involving an undercut using windows. FIG. 16A shows a conversion layer before wet etching.

FIG. 16B shows a conversion layer after wet etching for the first time.

FIG. 16C shows a conversion layer in water after wet etching for the second time.

FIG. 16D shows a conversion layer after drying after wet etching for the second time.

Various approaches were attempted in a fabrication process. Wet etching using CPD was successful for 100 μm and 300 μm layers. Vapor etching and/or backside etching may also be used.

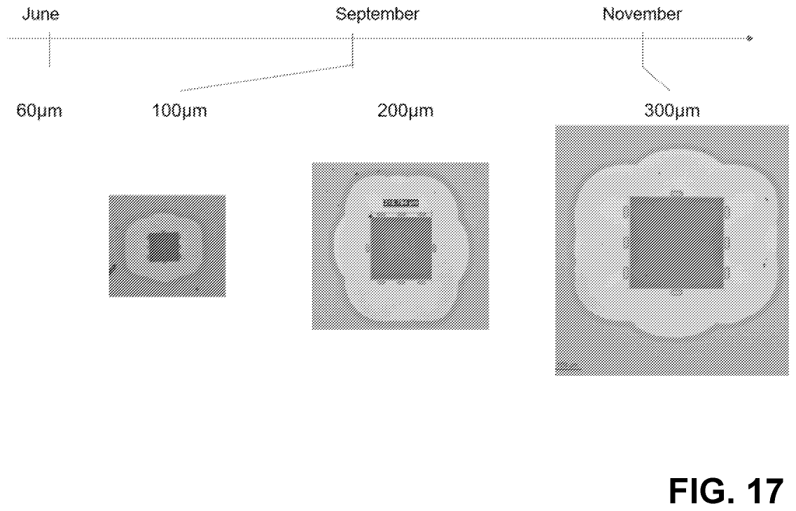

FIG. 17 shows progression of fabrication tests from 60 μm to 300 μm.

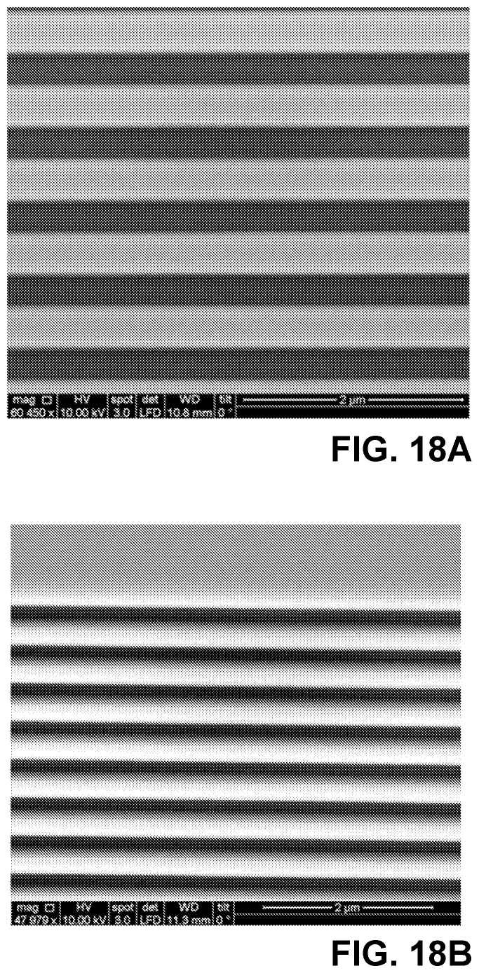

FIG. 18A shows a horizontal view of a conversion layer for design parameter confirmation.

FIG. 18B shows a 45 degree tilt view of a conversion layer for design parameter confirmation. The example conversion layer had design parameters of 680 nm periodicity and 310 nm air gap width. The example conversion layer had measured parameters (pre-HF) of 676.9 nm periodicity and 350 nm air gap width.

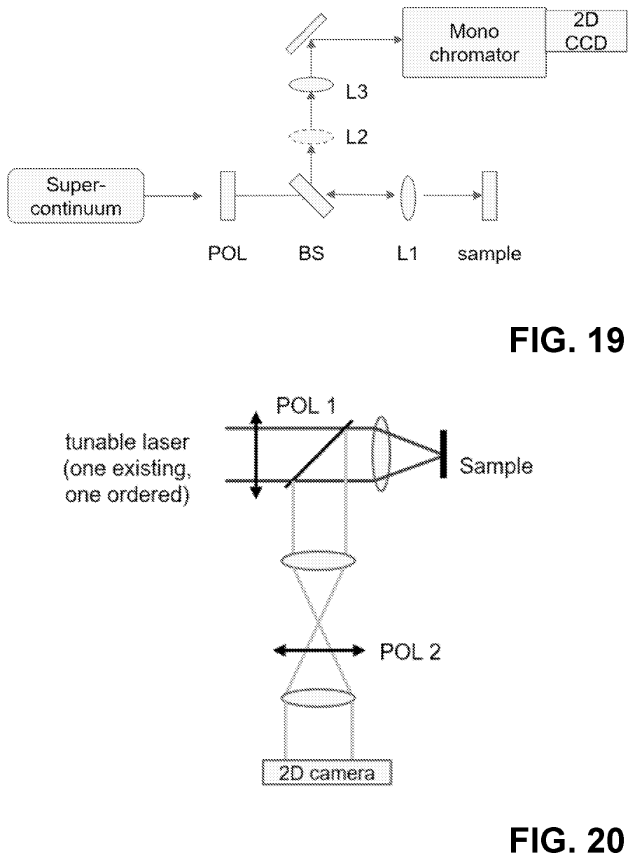

FIG. 19 shows a testing schematic. The testing schematic comprises a plurality of lenses L1, L2, and L3. The schematic comprising a polarizing. A mirror, a monochromator, a 2d CCD camera, and a super continuum.

FIG. 20 shows another testing schematic. A tunable laser may send an optical signal. After passing though POL 1, the light may reflect off the sample and be directed to a 2D camera. The setup may be used for narrowband characterization.

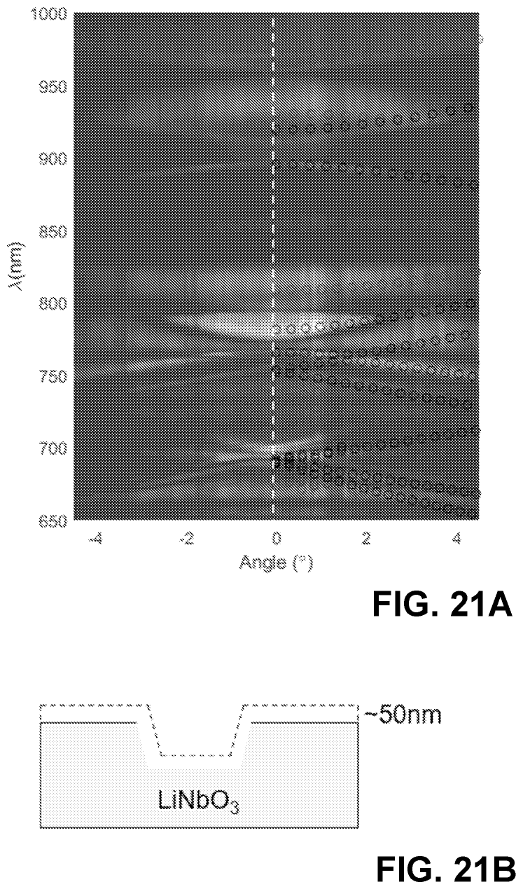

FIG. 21A shows wavelength shift due to wet etching.

FIG. 21B shows a conversion layer thinned by wet etching. About 1 hour of HF may slowly thin the conversion layer by about 50 nm.

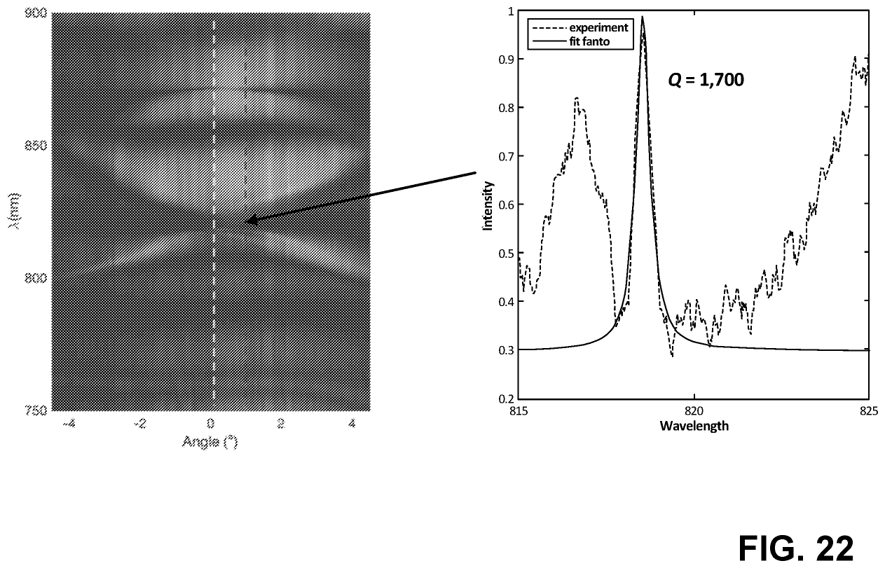

FIG. 22 shows BIC characteristics including wavelength and angle as well as intensity and wavelength. The characteristics are for Q=1,700.

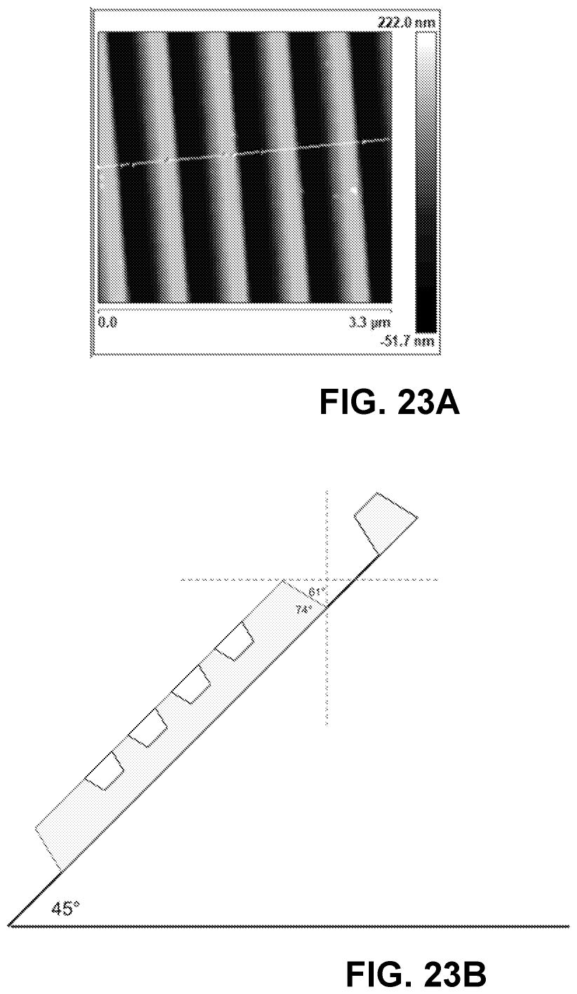

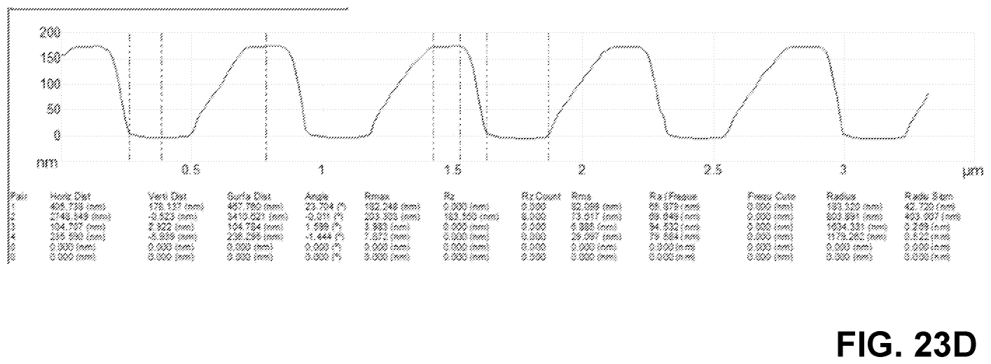

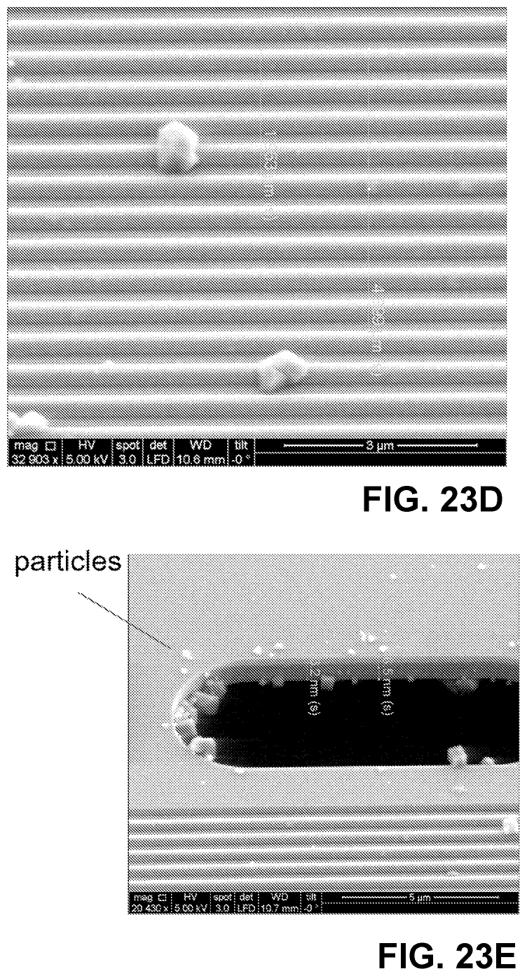

FIGS. 23A-E show AFM and SEM confirmation an example device.

FIG. 23A shows an example conversion layer.

FIG. 23B shows a cross-section of an example conversion layer.

FIG. 23C show measurements of a conversion layer. The air gap width had a design of 310 nm with a measured value of 580 nm. This confirmed that the air gap was largely expanded compared with design.

FIG. 23D shows a view of an example conversion layer. The view shows that a=690.95 nm.

FIG. 23E shows a view of an example conversion layer. The view shows particles and h=780 nm.

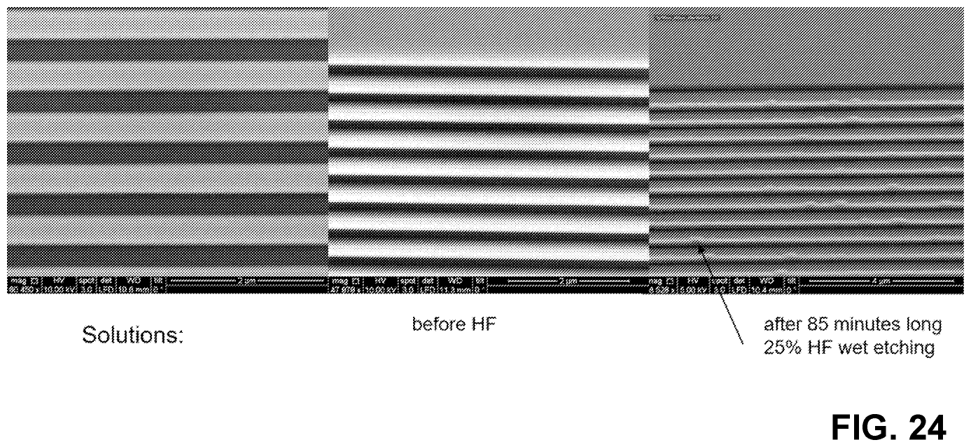

FIG. 24 shows a progression of a conversion layer. The middle view shows before HF. The right view shows after 85 minutes of 25% HF wet etching. Vapor etching for 100 μm may also be performed.

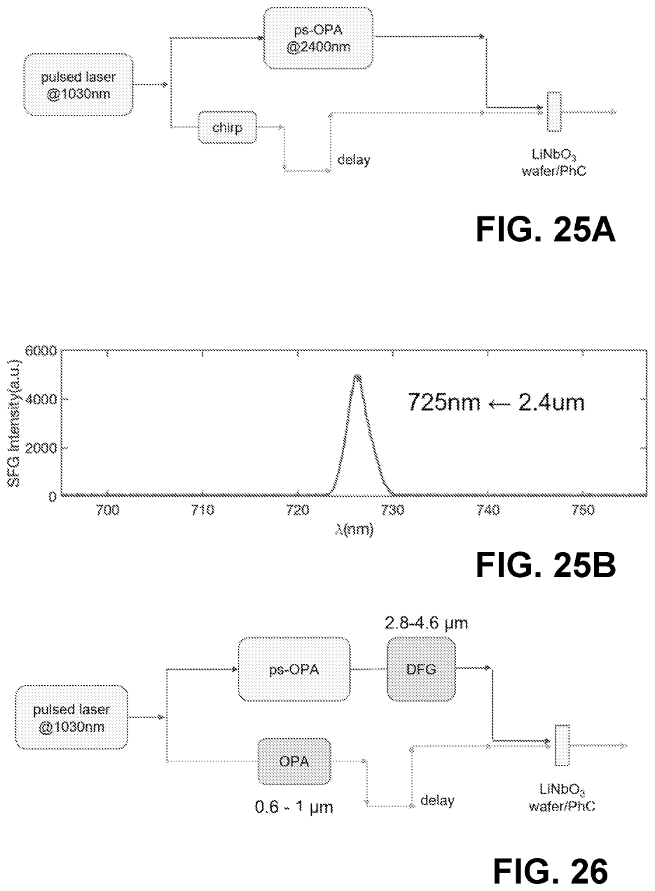

FIG. 25A shows a setup for a conversion layer. The conversion layer may use a non-linear conversion layer. The setup may comprise a pulsed laser (e.g., 1030 nm), a chirp, a ps-OPA (e.g. 2400 nm), a delay element, and a conversion layer (e.g., LiNbO₃).

FIG. 25B shows a graph illustrating SFG intensity and wavelength for the example conversion layer.

FIG. 26 shows an updated pulsed layer setup. The setup may comprise a pulse laser, a ps-OPA, a DFG, an OPA, a delay, and a conversion layer.

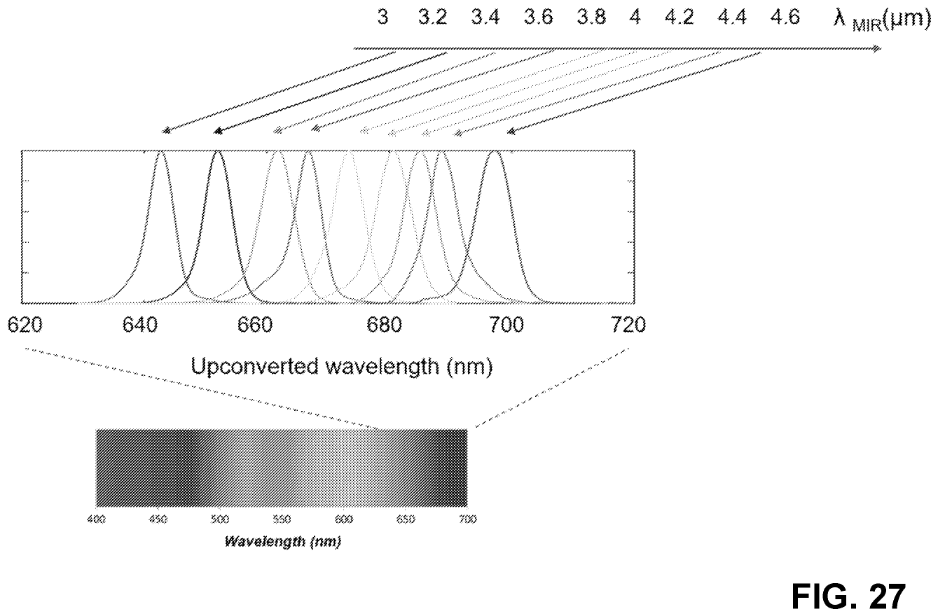

FIG. 27 shows observation of upconversion of an example device. Pump resonance may be at 816 nm.

The disclosure may comprise any of the following aspects.

Aspect 1. A device (or system) comprising, consisting of, or consisting essentially of: a conversion layer comprising a nonlinear optical material with a surface structure disposed to receive a pump signal and cause a bound states in the continuum (BIC) optical mode, wherein the conversion layer is configured to convert, based on nonlinear interaction with the BIC optical mode, an incoming signal incident on the conversion layer from an incoming wavelength to a target wavelength.

Aspect 2. The device of Aspect 1, wherein the BIC optical mode is caused based on the pump signal having a frequency that matches a resonance of the surface structure.

Aspect 3. The device of any one of Aspects 1-2, wherein the surface structure comprises a plurality of surface features disposed in one or more of a one-dimensional pattern or a two dimensional pattern.

Aspect 4. The device of Aspect 3, wherein the plurality of surface features are arranged in a periodic or semi-periodic pattern.

Aspect 5. The device of any one of Aspects 3-4, wherein the plurality of surface features have a periodicity in a range between a pump wavelength of the pump signal and the target wavelength.

Aspect 6. The device of any one of Aspects 3-4, wherein the plurality of surface features comprises one or more of slots or holes in the surface of the conversion layer.

Aspect 7. The device of any one of Aspects 1-6, wherein the conversion layer comprises a thin film layer, a crystal slab, a photonic crystal, or a combination thereof.

Aspect 8. The device of any one of Aspects 1-7, wherein the bound states in the continuum (BIC) optical mode comprises a quasi-BIC optical mode.

Aspect 9. The device of any one of Aspects 1-8, wherein the nonlinear optical structure comprises lithium niobate (LiNbO3), Magnesium oxide doped lithium niobate (MgO:LiNbO3), a III-V compound semiconductor, gallium arsenide (GaAs), indium phosphide (InP), aluminum gallium arsenide (AlGaAs), a III-nitride semiconductor, gallium nitride (GaN), aluminum nitride (AlN) and scandium doped aluminum nitride (AlScN), a monolayer material, a two-dimensional material, molybdenum disulfide (MoS2), molybdenum diselenide (MoSe2), gallium selenide (GaSe), tungsten disulfide (WS2), tungsten diselenide (WSe2), a materials with a second-order nonlinear susceptibility, or a combination thereof.

Aspect 10. The device of any one of claims 1-9, wherein the Q-factor of the BIC optical mode is one or more of: greater than 500, greater than 1,000,000, in a range between 500 and 10,000,000, or in a range from 10,000 to 1,000,000.

Aspect 11. The device of any one of Aspects 1-10, wherein the target wavelength is greater than the incoming wavelength.

Aspect 12. The device of any one of Aspects 1-11, wherein the target wavelength is in the visible wavelength range and the incoming wavelength is in the mid-infrared wavelength range.

Aspect 13. The device of any one of Aspects 1-12, further comprising a pump source configured to output the pump signal.

Aspect 14. The device of any one of Aspects 1-13, wherein the nonlinear interaction comprises sum-frequency generation.

Aspect 15. The device of any one of Aspects 1-14, further comprising an additional conversion layer configured to convert, based on an additional BIC optical mode of the additional conversion layer, a signal output from the conversion layer from the target wavelength to an additional target wavelength.

Aspect 16. The device of any one of Aspects 1-15, wherein a thickness of the conversion layer is in a range of about 0.2 to about 10 times a pump wavelength of the pump signal.

Aspect 17. A method comprising, consisting of, or consisting essentially of:
receiving, by a conversion layer comprising a nonlinear optical material with a surface structure, a pump signal; causing, by the conversion layer and based on the pump layer, a bound states in the continuum (BIC) optical mode; and converting, based on nonlinear interaction with the BIC optical mode, an incoming signal incident on the conversion layer from an incoming wavelength to a target wavelength.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

### REFERENCE

1. Hsu C W, Zhen B, Lee J, Chua S-L, Johnson S G, Joannopoulos J D, Soljačić M (2013) Observation of trapped light within the radiation continuum. Nature, 499(7457):188-191. link: https://www.nature.com/articles/nature12289
2. Jin J, Yin X, Ni L, Soljačić M, Zhen B, Peng C (2019) Topologically enabled ultrahigh-Q guided resonances robust to out-of-plane scattering. Nature, 574(7779):501-504. link: https://www.nature.com/articles/s41586-019-1664-7
3. Yin X, Jin J, Soljačić M, Peng C, Zhen B (2020) Observation of topologically enabled unidirectional guided resonances. Nature, 580(7804):467-471. link: https://www.nature.com/articles/s41586-020-2181-4
4. Hsu C W, Zhen B, Stone A D, Joannopoulos J D, Soljačić M (2016) Bound states in the continuum. Nature Reviews Materials, 1:16048. link: https://www.nature.com/articles/natrevmats201648
5. Lee J, Zhen B, Chua S-L, Qiu W, Joannopoulos J D, Soljačić M, Shapira O (2012) Observation and differentiation of unique high-Q optical resonances near zero wave vector in macroscopic photonic crystal slabs. Physical review letters, 109(6):067401. link: https://journals.aps.org/prl/abstract/10.1103/PhysRevLett.109.067401
6. Zhen B, Hsu C W, Lu L, Stone A D, Soljačić M (2014) Topological nature of optical bound states in the continuum. Physical review letters, 113(25):257401. link: https://journals.aps.org/prl/abstract/10.1103/PhysRevLett.113.257401
7. Li M, Ling J, He Y, Javid U A, Xue S, Lin Q (2020) Lithium niobate photonic-crystal electro-optic modulator. Nature communications, 11(1):4123. link: https://www.nature.com/articles/s41467-020-17950-7
8. Luo R, Jiang H, Rogers S, Liang H, He Y, Lin Q (2017) On-chip second-harmonic generation and broadband parametric down-conversion in a lithium niobate microresonator. Optics express, 25(20):24531-24539. link: https://www.osapublishing.org/oe/fulltext.cfm?uri=oe-25-20-24531&id=373724
9. Liang H, Luo R, He Y, Jiang H, Lin Q (2017) High-quality lithium niobate photonic crystal nanocavities. Optica, 4(10):1251-1258. link: https://www.osapublishing.org/optica/fulltext.cfm?uri=optica-4-10-1251&id=375095
10. He Y, Liang H, Luo R, Li M, Lin Q (2018) Dispersion engineered high quality lithium niobate microring resonators. Optics express, 26(13):16315-16322. link: https://www.osapublishing.org/oe/fulltext.cfm?uri=oe-26-13-16315&id=390560
11. Jiang H, Liang H, Luo R, Chen X, Chen Y, Lin Q (2018) Nonlinear frequency conversion in one dimensional lithium niobate photonic crystal nanocavities. Applied physics letters, 113(2):021104. link: https://aip.scitation.org/doi/10.1063/1.5039948
12. Luo R, He Y, Liang H, Li M, Lin Q (2018) Highly tunable efficient second-harmonic generation in a lithium niobate nanophotonic waveguide. Optica, 5(8):1006-1011. link: https://www.osapublishing.org/optica/fulltext.cfm?uri=optica-5-8-1006&id=396207
13. Li M, Liang H, Luo R, He Y, Ling J, Lin Q (2019) Photon-level tuning of photonic nanocavities. Optica, 6(7):860. link: https://www.osapublishing.org/optica/fulltext.cfm?uri=optica-6-7-860&id=415008
14. Ling J, He Y, Luo R, Li M, Liang H, Lin Q (2020) Athermal lithium niobate microresonator. Optics express, 28(15):21682-21691. link: https://www.osapublishing.org/oe/fulltext.cfm?uri=oe-28-15-21682&id=433282
15. Li G, Zhang S, Zentgraf T (2017) Nonlinear photonic metasurfaces. Nature Reviews Materials, 2(5):1-4. link: https://doi.org/10.1038/natrevmats.2017.10
16. Krasnok A, Tymchenko M, Alu A (2018) Nonlinear metasurfaces: a paradigm shift in nonlinear optics. Materials Today, 1; 21(1):8-21. link: https://doi.org/10.1016/i.mattod.2017.06.007
17. Hum, D. S., & Fejer, M. M. (2007). Quasi-phasematching. Comptes Rendus Physique, 8(2), 180-198. link: https://doi.org/10.1016/j.crhy.2006.10.022
18. Helmy A S, Abolghasem P, Stewart Aitchison J, Bijlani B J, Han J, Holmes B M, Hutchings D C, Younis U, Wagner S J (2011) Recent advances in phase matching of second-order nonlinearities in monolithic semiconductor waveguides. Laser & Photonics Reviews, 8; 5(2):272-86.
link: https://doi.org/10.1002/lpor.201000008

What is claimed:

1. A device comprising:
a conversion layer comprising a nonlinear optical material with a surface structure disposed to receive a pump signal and cause a bound states in the continuum (BIC) optical mode,
wherein the conversion layer is configured to convert, based on nonlinear interaction with the BIC optical mode, an incoming signal incident on the conversion layer from an incoming wavelength to a target wavelength.

2. The device of claim 1, wherein the BIC optical mode is caused based on the pump signal having a frequency that matches a resonance of the surface structure.

3. The device of claim 1, wherein the surface structure comprises a plurality of surface features disposed in one or more of a one-dimensional pattern or a two dimensional pattern.

4. The device of claim 3, wherein the plurality of surface features are arranged in a periodic or semi-periodic pattern.

5. The device of claim 3, wherein the plurality of surface features have a periodicity in a range between a pump wavelength of the pump signal and the target wavelength.

6. The device of claim 3, wherein the plurality of surface features comprises one or more of slots or holes in the surface of the conversion layer.

7. The device of claim 1, wherein the conversion layer comprises a thin film layer, a crystal slab, a photonic crystal, or a combination thereof.

8. The device of claim 1, wherein the bound states in the continuum (BIC) optical mode comprises a quasi-BIC optical mode.

9. The device of claim 1, wherein the nonlinear optical structure comprises lithium niobate (LiNbO3), Magnesium oxide doped lithium niobate (MgO:LiNbO3), a III-V compound semiconductor, gallium arsenide (GaAs), indium phosphide (InP), aluminum gallium arsenide (AlGaAs), a III-nitride semiconductor, gallium nitride (GaN), aluminum nitride (AlN) and scandium doped aluminum nitride (AlScN), a monolayer material, a two-dimensional material, molybdenum disulfide (MoS2), molybdenum diselenide (MoSe2), gallium selenide (GaSe), tungsten disulfide (WS2), tungsten diselenide (WSe2), a materials with a second-order nonlinear susceptibility, or a combination thereof.

10. The device of claim 1, wherein the Q-factor of the BIC optical mode is one or more of: greater than 500, greater than 1,000,000, in a range between 500 and 10,000,000, or in a range from 10,000 to 1,000,000.

11. The device of claim 1, wherein the target wavelength is greater than the incoming wavelength.

12. The device of claim 1, wherein the target wavelength is in the visible wavelength range and the incoming wavelength is in the mid-infrared wavelength range.

13. The device of claim 1, further comprising a pump source configured to output the pump signal.

14. The device of claim 1, wherein the nonlinear interaction comprises sum-frequency generation.

15. The device of claim 1, further comprising an additional conversion layer configured to convert, based on an additional BIC optical mode of the additional conversion layer, a signal output from the conversion layer from the target wavelength to an additional target wavelength.

16. The device of claim 1, wherein a thickness of the conversion layer is in a range of about 0.2 to about 10 times a pump wavelength of the pump signal.

17. A method comprising:
receiving, by a conversion layer comprising a nonlinear optical material with a surface structure, a pump signal;
causing, by the conversion layer and based on the pump layer, a bound states in the continuum (BIC) optical mode; and
converting, based on nonlinear interaction with the BIC optical mode, an incoming signal incident on the conversion layer from an incoming wavelength to a target wavelength.

18. The method of claim 17, wherein the BIC optical mode is caused based on the pump signal having a frequency that matches a resonance of the surface structure.

19. The method of claim 17, wherein the surface structure comprises a plurality of surface features disposed in one or more of a one-dimensional pattern or a two dimensional pattern.

20. The method of claim 19, wherein the plurality of surface features are arranged in a periodic or semi-periodic pattern.
